(19) United States
(12) Patent Application Publication
(10) Pub. No.: US 2013/0275154 A1
(43) Pub. Date: Oct. 17, 2013

(54) APPARATUS AND METHOD FOR PREDICTING POTENTIAL DEGREE OF CORONARY ARTERY CALCIFICATION (CAC) RISK

(71) Applicants: SAMSUNG ELECTRONICS CO., LTD., Suwon-si (KR); SAMSUNG LIFE WELFARE FOUNDATION, Seoul (KR)

(72) Inventors: Hye-Jin Kam, Seongnam-si (KR); Ha-Young Kim, Hwaseong-si (KR); Sang-Hyun Yoo, Seoul (KR); Ji-Hyun Lee, Hwaseong-si (KR); Yoonho Choi, Seoul (KR); Mira Kang, Seoul (KR); Jeongeuy Park, Seoul (KR); Jidong Sung, Seoul (KR); Heeyoung Shin, Seoul (KR); Sungwon Cho, Seoul (KR); Soojin Cho, Seoul (KR)

(21) Appl. No.: 13/834,150

(22) Filed: Mar. 15, 2013

(30) Foreign Application Priority Data
Mar. 15, 2012 (KR) 10-2012-0026811

(51) Int. Cl. G06F 19/00; G06Q 50/24

(52) U.S. Cl. CPC G06F 19/3431; G06Q 50/24
USPC 705/3

(57) ABSTRACT

A method of predicting a potential degree of Coronary Artery Calcification (CAC) risk includes receiving a patient's medical test data relating to CAC; determining a cluster to which the patient's medical test data belong based on an age of the patient; extracting a risk factor score including at least two Coronary Artery Calcification Scores (CACSs) from the medical test data; storing a plurality of prediction models used for predicting a potential degree of CAC risk; and predicting a potential degree of CAC risk at a specific point in time by applying a CACS growth rate of the patient's medical test data calculated using the at least two CACSs of the patient's medical test data and the extracted risk factor score to a prediction model corresponding to the determined cluster to which the patient's medical test data belong among the plurality of prediction models.

### CROSS-REFERENCE TO RELATED APPLICATIONS

This application claims the benefit under 35 USC 119(a) of Korean Patent Application No. 10-2012-0026811 filed on Mar. 15, 2012, the entire disclosure of which is incorporated herein by reference for all purposes.

### BACKGROUND

1. Field

The following description relates to technology for predicting a patient's potential degree of Coronary Artery Calcification (CAC) risk at a specific point in time.

2. Description of Related Art

Coronary artery disease (CAD) is a leading cause of death in developed countries. About one-half of CAD patients experience myocardial infarction (MI) or acute myocardial infarction (AMI), and some of them die of MI or AMI.

A Coronary Artery Calcium Score (CACS) is closely related to heart diseases.

The CACS is obtained by means of computed tomography (CT) or another medical imaging process, and indicates progression of atherosclerosis and an accumulated amount of plaques in an artery. If CACS increases, the chances that MI or heart diseases might occur are high.

For this reason, it is important for a patient, especially a high-risk patient, to measure have a CACS measured to thereby be informed of a heart disease risk.

Reportedly, advanced age, current smoking, high blood pressure, diabetes, high cholesterol, low-density lipoprotein (LDL) cholesterol, high-density lipoprotein (HDL) cholesterol, obesity, and kidney disease are associated with an increase in CACS.

However, existing studies simply present statistical differences between a patient group and a healthy group on the basis of a risk factor, but fail to suggest a quantified risk degree of each risk factor, a collective effect of integrated risk factors, or an effective prediction model.

Furthermore, although various medical tests reflect newly-found risk factors in their results, the test results are not used to predict whether CACS would increase. That is, numerous studies simply help to predict occurrence of angina pectoris, MI, or cerebral infarction, which are heart diseases caused by an increased CACS.

### SUMMARY

In one general aspect, a method of predicting a potential degree of Coronary Artery Calcification (CAC) risk includes receiving a patient's medical test data relating to CAC; determining a cluster to which the patient's medical test data belong based on an age of the patient; extracting a risk factor score including at least two Coronary Artery Calcification Scores (CACSs) from the patient's medical test data; storing a plurality of prediction models used for predicting a potential degree of CAC risk; and predicting a potential degree of CAC risk at a specific point in time by applying a CACS growth rate of the patient's medical test data calculated using the at least two CACSs of the patient's medical test data and the extracted risk factor score to a prediction model corresponding to the determined cluster to which the patient's medical test data belong among the plurality of prediction models.

The predicting of the potential degree of CAC risk may include comparing the CACS growth rate of the patient's medical test data with an average CACS growth rate of all medical test data of the determined cluster to which the patient's medical test data belong.

The extracted risk factor score may include any one or any combination of a body mass index (BMI) value, a high-density lipoprotein(HDL) cholesterol level, an age, a triglyceride level, and a value determined according to whether the patient is a smoker or a non-smoker.

In another general aspect, an apparatus for predicting a potential degree of Coronary Artery Calcification (CAC) risk includes a receiving unit configured to receive a patient's medical test data relating to CAC; a cluster determining unit configured to determine a cluster to which the patient's medical test data belong based on an age of the patient; a risk factor score extracting unit configured to extract a risk factor score including at least two Coronary Artery Calcification Scores (CACSs) from the patient's medical test data; a prediction model storage unit configured to store a plurality of prediction models for predicting a potential degree of CAC risk; and a predicting unit configured to predict a potential degree of CAC risk at a specific point in time by applying a CACS growth rate of the patient's medical test data calculated using the at least two CACSs of the patient's medical test data and the extracted risk factor score to a prediction model corresponding to the determined cluster to which the patient's medical test data belong among the plurality of prediction models.

The predicting unit may be further configured to predict the potential degree of CAC risk by comparing the CACS growth rate of the patient's medical test data with an average CACS growth rate of all medical test data of the cluster to which the patient's medical test data belong.

The extracted risk factor score may include any one or any combination of a body mass index (BMI) value, a high-density lipoprotein (HDL) cholesterol level, an age, a triglyceride level, and a value determined according to whether the patient is a smoker or a non-smoker.

In another general aspect, an apparatus for predicting a potential degree of Coronary Artery Calcification (CAC) risk includes a receiving unit configured to receive a patient's medical test data relating to CAC and corresponding operation information; a cluster determining unit configured to determine a cluster to which the patient's medical test data belong based on a characteristic of the patient; a risk factor score extracting unit configured to extract from the patient's medical test data a risk factor score of a risk factor of a risk factor set of the determined cluster to which the patient's medical test data belong; a prediction model storage unit configured to store a plurality of prediction models used for predicting a potential degree of CAC risk; a prediction model learning unit configured to perform machine learning by applying the extracted risk factor score to a prediction model corresponding to the determined cluster among the plurality of prediction models; and a predicting unit configured to obtain an outcome by applying the extracted risk factor score to the prediction model corresponding to the determined cluster.

The prediction model learning unit may be further configured to perform the machine learning when the operation information is a learning instruction; and the predicting unit may be further configured to obtain the outcome when the operation information is the predicting instruction.

The extracted risk factor score may include at least two Coronary Artery Calcification Scores (CACSs).

The characteristic of the patient may be an age of the patient; and the cluster determining unit may be further configured to determine the cluster to which the patient's medical test data belong based on the age of the patient.

The prediction model learning unit may be further configured to calculate a CACS growth rate of the patient's medical test data from the at least two CACSs.

The prediction model learning unit may be further configured to perform the machine learning by comparing the CACS growth rate of the patient's medical test data with a reference CACS growth rate of all medical test data of the determined cluster to which the patient's medical test data belong; assigning a first outcome to the patient's medical test data when the CACS growth rate of the patient's medical test data is greater than the reference CAC growth rate; and assigning a second outcome to the patient's medical test data in other cases.

When the predicting unit obtains the first outcome when the patient's medical test data is received with the predicting instruction, a potential CAC risk of the patient may be predicted to increase; and when the predicting unit obtains the second outcome when the patient's medical test data is received with the predicting instruction, the potential CAC risk of the patient may be predicted not to increase.

In another general aspect, a method of predicting a potential degree of Coronary Artery Calcification (CAC) risk includes receiving a patient's medical test data relating to CAC and corresponding operation information; determining a cluster to which the patient's medical test data belong based on a characteristic of the patient; extracting from the patient's medical test data a risk factor score of a risk factor of a risk factor set of the determined cluster to which the patient's medical test data belong; and selectively performing machine learning or prediction using a prediction model according to the operation information.

The characteristic of the patient may be an age of the patient; and the determining of the cluster to which the patient's medical test data belong may include determining the cluster to which the patient's medical test data belong based on the age of the patient.

The selectively performing of the machine learning or the prediction using a prediction model may include performing the machine learning by applying the extracted risk factor score to a prediction model corresponding to the determined cluster to which the patient's medical test data belong among a plurality of prediction models when the operation information is a learning instruction; and performing the prediction by applying the extracted risk factor score to the prediction model corresponding to the determined cluster to which the patient's medical test data belong when the operation information is a predicting instruction.

The extracted risk factor score may include at least two Coronary Artery Calcification Scores (CACSs).

The performing of the machine learning may include calculating a CACS growth rate of the patient's medical test data using the at least two CACSs.

The performing of the machine learning may further include comparing the CACS growth rate of the patient's medical test data with a reference CACS growth rate of all medical test data of the determined cluster to which the patient's medical test data belong; assigning a first outcome to the patient's medical test data when the CACS growth rate of the patient's medical test data is greater than the reference CACS growth rate; and assigning a second outcome to the patient's medical test data in other cases.

When the performing of the prediction using a prediction model obtains the first outcome when the patient's medical test data is received with the predicting instruction, a potential CAC risk of the patient may be predicted to increase; and when the performing of the prediction using a prediction model obtains the second outcome when the patient's medical test data is received with the predicting instruction, the potential CAC risk of the patient may be predicted not to increase.

Other features and aspects will be apparent from the following detailed description, the drawings, and the claims.

### BRIEF DESCRIPTION OF THE DRAWINGS

FIG. 1 is a block diagram illustrating an example of an apparatus for predicting a potential degree of CAC risk.

FIG. 2 is a block diagram illustrating another example of an apparatus for predicting a potential degree of CAC risk.

FIG. 3 is a block diagram illustrating elements of the apparatus for predicting a potential degree of CAC risk shown in FIG. 2 that are activated when operation information is a learning instruction.

FIG. 4 is a block diagram illustrating elements of the apparatus for predicting a potential degree of CAC risk shown in FIG. 2 that are activated when operation information is a predicting instruction.

FIG. 5 is a flow chart illustrating an example of a method of predicting a potential degree of CAC risk.

FIG. 6 is a flow chart illustrating a detailed example of the method of FIG. 5.

### DETAILED DESCRIPTION

The following description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

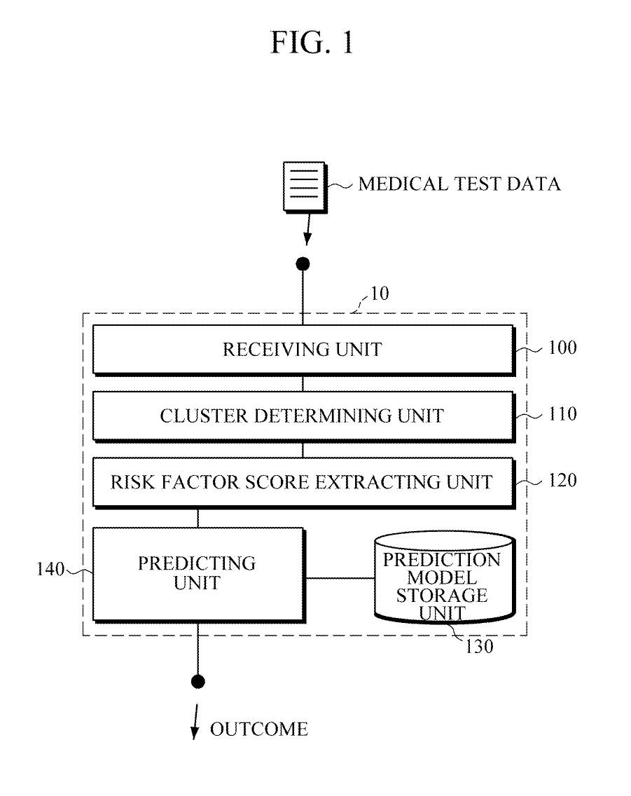

FIG. 1 is a block diagram illustrating an example of an apparatus for predicting a potential degree of Coronary Artery Calcification (CAC) risk.

Referring to FIG. 1, the apparatus 10 for predicting a potential degree of CAC risk includes a receiving unit 100, a cluster determining unit 110, a risk factor score extracting unit 120, a prediction model storage unit 130, and a predicting unit 140.

The receiving unit 100 receives a patient's medical test data relating to CAC.

The cluster determining unit 110 determines a cluster to which the medical test data belong based on the patient's age. The patient's age may be included in the medical test data.

The risk factor extracting unit 120b extracts a risk factor score from the medical test data.

The risk factor score may include at least two Coronary Artery Calcification Scores (CACS), and each CACS may include any one or any combination of a body mass index (BMI) value, a HDL cholesterol level, an age, a triglycerides (TG) level, and a value determined according to whether the patient is a smoker or a non-smoker. However, these are merely examples, and other types of values may be included.

The prediction model storage unit 130 stores a plurality of prediction models for predicting a potential degree of CAC risk.

By applying a CACS growth rate of the medical test data calculated using at least two CACSs and the extracted risk factor score to a prediction model corresponding to the determined cluster to which the medical test data belong, the predicting unit 140 predicts a potential degree of CAC risk.

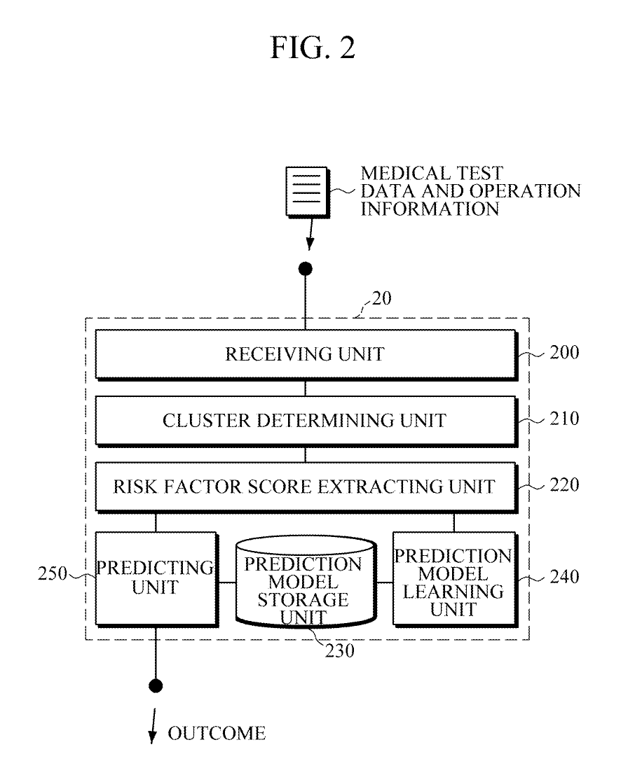

FIG. 2 is a block diagram illustrating another example of an apparatus for predicting a potential degree of CAC risk.

The following two conditions enable a potential degree of a patient's CAC risk to be predicted.

First, a prediction model (that is, a prediction model used for predicting a potential degree of CAC risk) needs to be learned for predicting a patient's potential degree of CAC risk based on medical test data from various medical tests including computed tomography (CT).

Second, an outcome indicative of a potential degree of CAC risk needs to be obtained by applying a specific patient's medical test data to the learned prediction model.

However, prediction is not always accompanied by machine learning. For example, a doctor himself is able to do what machine learning does. FIG. 1 is an example of an apparatus for predicting a potential degree of CAC risk that predicts a potential degree of CAC risk without performing machine learning.

In contrast, FIG. 2 is an example of an apparatus for predicting a potential degree of CAC risk that performs machine learning while predicting a potential degree of CAC risk based on received medical test data.

Referring to FIG. 2, the apparatus 20 for predicting a potential degree of CAC risk includes a receiving unit 200, a cluster determining unit 210, a risk factor score extracting unit 220, a prediction model storage unit 230, a prediction model learning unit 240, and a predicting unit 250.

The receiving unit 200 receives a patient's medical test data relating to CAC and corresponding operation information.

Medical test data is a collection of data about various medical tests and diagnoses with respect to a patient. A risk factor included in the medical test data may or may not be directly related to progression of CAC. Therefore, only a value of a risk factor (that is, a risk factor score) that has a profound statistical significance for progression of CAC should be selectively extracted and then applied to a prediction model for predicting a potential degree of CAC risk.

Operation information is an instruction that points out a type of an operation to be performed with respect to received medical test data. For example, the operation information may be an instruction that is input by selecting an appropriate operation button in a menu arranged in the apparatus for predicting a potential degree of CAC risk.

If the operation information is a learning instruction, the prediction model learning unit 240 performs machine learning on a prediction model using the medical test data. Alternatively, if the operation information is a predicting instruction, the predicting unit 250 predicts a patient's potential degree of CAC risk using the medical test data relating to CAC.

The cluster determining unit 210 determines a cluster to which a patient's medical test data belong based on at least one characteristic of the patient. The at least one characteristic of the patient may be included in the patient's medical test data.

A cluster is a collection of medical test data having a common characteristic. Thus, if a prediction model optimized for all of the medical test data belonging to the same cluster is employed with respect to the cluster, prediction accuracy may improve profoundly.

For example, patients may be classified into a plurality of clusters based on the patients' ages, and each cluster is representative of a specific CACS range.

Table 1 below illustrates an example in which all patients are classified into two clusters based on the patients' ages.

TABLE 1

| Cluster | Age |
|---|---|
| Cluster 1 | Equal to or Older than Age 60 |
| Cluster 2 | Younger than Age 60 |

Patients may be classified into more than two clusters based on the patients' ages, or may be classified based on a combination of age and some other characteristic.

The risk factor score extracting unit 220 extracts from the medical test data at least one risk factor score of at least one risk factor of a risk factor set of a cluster to which the medical test data belong.

A risk factor is a factor that affects a potential degree of CAC risk. For example, a patient's first measured CACS, a blood pressure level, and a cholesterol level are highly significant risk factors. A value of a risk factor, that is, a risk factor score, is included in the medical test data. If a risk factor is age, a patient's age (for example, 30) is included in the patient's medical test data as a risk factor score. A different risk factor set may be applied to each prediction model.

Table 2 below shows an example of a format of a risk factor set applied to a prediction model.

TABLE 2

| Risk Factor Set | Model | Risk Factor | OR | CI (95%) | | P-Value |
|---|---|---|---|---|---|---|
| RFS₁ | Model₁ | RF₁ | 1.01 | 1.01 | 1.01 | 3.54E−07 |
| | | RF₂ | 0.13 | 0.11 | 0.15 | <2E−16 |
| | | . . . | . . . | . . . | . . . | . . . |
| . . . | . . . | . . . | . . . | . . . | . . . | . . . |

A risk factor set RFS₁ shown in Table 2 consists of a plurality of risk factors RF₁, RF₂, . . . . Among the factors included in each medical test data, a factor closely related to progression of CAC is used as a risk factor. For example, a risk factor set may include a value of a significant risk factor, such as a first measured CACS, a blood pressure level, an age, a value determined according to whether the patient is a smoker or a non-smoker, a value determined according to whether the patient has diabetes, a LDL cholesterol level, and an HDL cholesterol level.

Each risk factor may include additional fields to show an odds ratio (OR) between the risk factor and a progression of CAC, a confidence interval of the OR (for example, a confidence level of 95%), and a statistical significance (a P-Value) of the OR.

The prediction model storage unit 230 stores a plurality of prediction models of a potential degree of CAC risk.

A different prediction model is employed with respect to each cluster. Therefore, if there are a plurality of clusters, a plurality of corresponding prediction models are provided. The plurality of prediction models are stored in the prediction model storage unit 230. In addition, if an operation is performed with respect to medical test data belonging to a specific cluster, a prediction model corresponding to the specific cluster is selected to be used.

The prediction model learning unit 240 performs machine learning by applying the risk factor score extracted by the risk factor score extracting unit 220 to the prediction model corresponding to the specific cluster to which the medical test data belong.

A wide range of machine learning algorithms may be used to perform machine learning on each prediction model. For example, a support vector machine (SVC), a decision tree, a multilayer perceptron (MLP), a LogitBoost, or any other machine learning algorithm known to one of ordinary skill in the art, or any combination thereof may be used.

A prediction model may be learned with respect to a patient's medical test data by receiving the medical test data and then performing machine learning on the prediction model using a specific algorithm. Next, if a patient's new medical test data is received, the prediction model may be employed to predict the patient's potential degree of CAC risk based on the new medical test data.

The predicting unit 250 obtains an outcome indicative of the patient's potential degree of CAC risk by applying a risk factor score extracted from the medical test data by the risk factor extracting unit 220 to a prediction model corresponding to a cluster to which the medical test data belong.

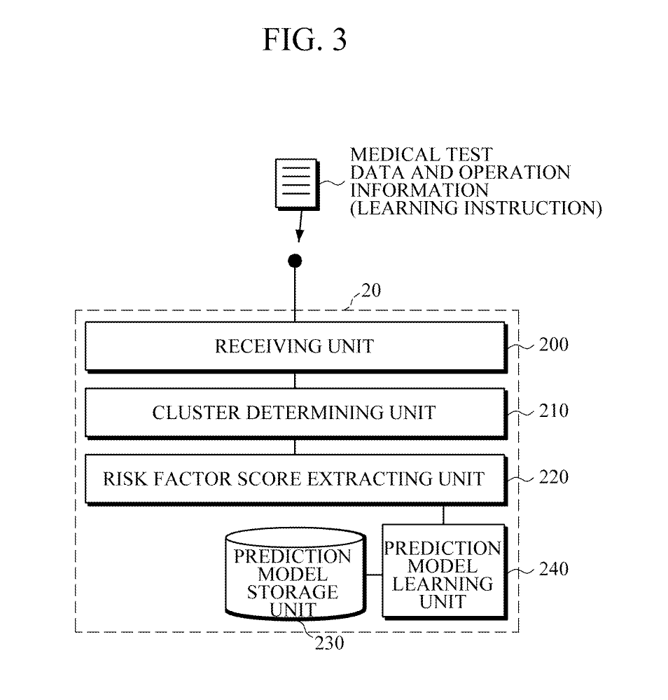

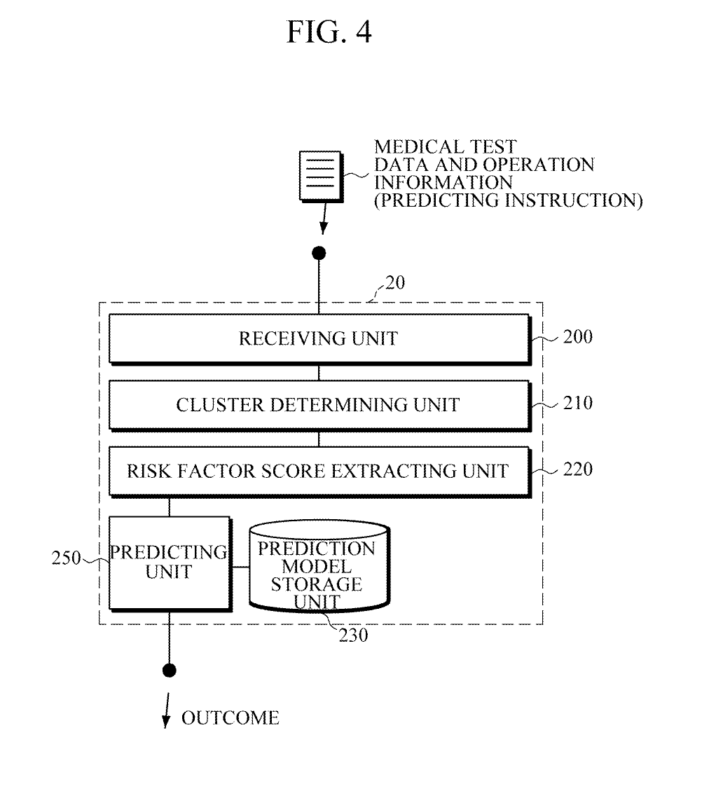

When medical test data is received in the apparatus 20 for predicting a potential degree of CAC risk shown in FIG. 2, the medical test data may be used to perform machine learning on a corresponding prediction model or to predict a potential degree of CAC risk. FIGS. 3 and 4 illustrate each of these cases.

FIG. 3 is a diagram illustrating an example of elements of the apparatus 20 for predicting a potential degree of CAC risk shown in FIG. 2 that are activated when operation information is a learning instruction.

If operation information is a learning instruction, elements of the apparatus 20 for predicting a potential degree of CAC risk shown in FIG. 2 that are used in performing machine learning on a prediction model using received medical test data are activated. These elements include the receiving unit 200, the cluster determining unit 210, the risk factor score extracting unit 220, the prediction model storage unit 230 and the prediction model learning unit 240 as shown in FIG. 3.

By using diverse medical test data as a training set, the prediction model learning unit 240 may calculate a CACS growth rate of a cluster to which such diverse medical test data belong. The average CACS growth rate may be used as a reference CACS growth rate which is to be compared with a CACS growth rate of medical test data of a particular patient.

FIG. 4 is a diagram illustrating an example of elements of the apparatus 20 for predicting a potential degree of CAC risk shown in FIG. 2 that are activated when operation information is a predicting instruction.

If operation information is a predicting instruction, elements of the apparatus 20 for predicting a potential degree of CAC risk shown in FIG. 2 that are used in predicting a potential degree of CAC risk by applying received medical test data to a prediction model corresponding to a cluster to which the medical test data belong are activated. These elements include the receiving unit 200, the cluster determining unit 210, the risk factor score extracting unit 220, the prediction model storage unit 230, and the prediction model learning unit 240 as shown in FIG. 4. The potential degree of CAC risk may be predicted at a specific point in time, for example, four years in the future. However, four years is merely one example, and other time periods may be used.

A CACS and a corresponding measurement date are risk factors that may be used for performing machine learning on a prediction model and predicting a potential degree of CAC risk using the learned prediction model.

Specifically, a prediction model should be learned. If at least two risk factor scores, each including a CACS and a corresponding measurement date, are extracted from medical test data, machine learning may be carried out by applying the first measured CACS and the last measured CACS, along with other risk factor scores included in the medical test data, to the prediction model corresponding to a cluster to which the medical test data belong.

Next, in order to obtain an outcome, the predicting unit calculates a CACS growth rate of the medical test data using at least two CACSs extracted by the risk factor score extracting unit. That is, a CACS growth rate of the medical test data is calculated using the first measured CACS and the last measured CACS, and then the CACS growth rate is compared with a reference CACS growth rate of a cluster to which the medical test data belong.

A reference CACS growth rate of a cluster to which medical test data belong may be an average CACS growth rate of all of the medical test data that have been used in performing machine learning on a prediction model corresponding to the cluster to which the medical test data belong.

Since different medical test data are used for a prediction model corresponding to each cluster, different clusters may have different average CACS growth rates.

A CACS growth rate of medical test data may be calculated according to the following Equation 1.

$$CACS Growth Rate = \frac{Last Measured CACS - First Measured CACS}{First Measured CACS} \qquad ( 1 )$$

Since there may be hundreds of CACSs in a cluster, Equation 1 may be modified into the following Equation 2 for the sake of convenience.

$$CACS Growth Rate = \frac{ln ( {score}_{follow \text{-} up} + C ) - ln ( {score}_{base} + C )}{ln ( {score}_{base} + C ) \times ( {year}_{follow \text{-} up} - {year}_{base} )} , \qquad ( 2 )$$

In Equation 2, score_{base} is the first measured CACS, year_{base} is the year in which score_{base} was measured, score_{follow-up} is the last measured CACS, year_{follow-up} is the year in which score_{follow-up} was measured, and C is a constant to prevent an error that can occur when score_{base} or score_{follow-up} is 0. That is, the purpose of C is to prevent the arguments of the In functions in Equation 2 from being 0. The value of C may be selected by a user, and may be a value that is much less than the values of score_{base} and score_{follow-up}.

Referring again to FIG. 2, the prediction model learning unit 240 compares the CACS growth rate of the medical test data with the reference CACS growth rate of the cluster to which the medical test data belong. The prediction model learning unit 240 assigns a first outcome to the medical test data when the CACS growth rate of the medical test data is greater than the reference CACS growth rate of the cluster to which the medical test data belong, and assigns a second outcome to the medical test data in other cases.

That is, when a CACS growth rate of medical test data is greater than a reference CACS growth rate of a cluster to which the medical test data belong, this indicates a severer state of CAC. In this case, the prediction model learning unit 240 may assign, for example, an outcome of “1” to the medical test data.

Alternatively, when a CACS growth of medical test data is smaller than a reference CACS growth rate of a cluster to which the medical test data belong, this indicates that a CAC risk has been maintained at a relatively constant level, or that CAC has been reduced or eliminated, during a period between CACS measurements. In this case, the prediction model learning unit 240 may assign, for example, an outcome of “0” to the medical test data.

Accordingly, if machine learning is performed on a prediction model by the prediction model learning unit 240 with respect to medical test data, the prediction model may be employed to predict a potential degree of CAC risk with respect to different medical test data belonging to the same cluster as the medical test data used to perform the machine learning. The potential degree of CAC risk may be predicted at a specific point in time, for example, four years in the future. However, four years is merely one example, and other time periods may be used.

That is, if the predicting unit 250 obtains an outcome of “1” when a patient's medical test data is received with a predicting instruction, a CACS growth rate of the patient's medical test data is predicted to be greater than an average CACS growth rate of all of the medical test data belonging to the same cluster as the patient's medical test data. The fact that the CACS growth rate of the patient's medical test data is greater than the average CACS growth rate of all of the medical test data of the cluster to which the patient's medical test data belong indicates that the patient's potential degree of CAC risk may be predicted to increase.

Similarly, if the prediction unit 250 obtains an outcome of “0” when a patient's medical test data is received with a predicting instruction, a CAC growth rate of the patient's medical test data is predicted to be smaller than an average CACS growth rate of all of the medical test data belonging to the same cluster as the patient's medical test data. The fact that the CACS growth rate of the patient's medical test data is smaller than the average CACS growth rate of all of the medical test data of the cluster to which the patient's medical test data belong indicates that the patient's potential degree of CAC risk may be predicted not to increase.

FIGS. 1 and 2 illustrate a case where patients are classified into two clusters (a cluster of patients equal to or older than age 60 and the other cluster of patients younger than age 60), but this is merely one example. That is, patients' medical test data may be clustered in various ways using a variety of existing clustering techniques.

However, there may be numerous standards reflecting a common characteristic between all of the medical test data belonging to the same cluster, and how to apply each of the standards (or a combination of the standards) may determine a type of a clustering technique to be used.

For example, if age is a clustering standard, a narrower or wider age range may be applied, or a greater or fewer number of clusters may be used.

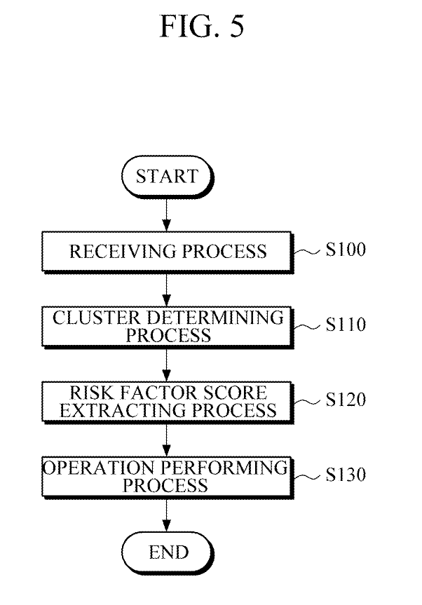

FIG. 5 is a flow chart illustrating an example of a method of predicting a potential degree of CAC risk. Referring to FIG. 5, the method of predicting a potential degree of CAC risk includes a receiving process S100, a cluster determining process S110, a risk factor score extracting process S120, and an operation performing process S130.

In the receiving process S100, a patient's medical test data relating to CAC and corresponding operation information are received in an apparatus for predicting a potential degree of CAC risk.

In the cluster determining process S110, clustering is performed on the medical test data received in the receiving process S100 based on at least one characteristic of the patient. The at least one characteristic of the patient may be included in the medical test data. Accordingly, a cluster to which the medical test data belong is determined.

For example, if medical test data is classified into two clusters based on a patient's age as a characteristic of a patient, for example, age 60, the received medical test data may belong to a cluster of patients equal to or older than age 60, or to a cluster of patients younger than 60.

In the risk factor score extracting process S120, at least one risk factor score of a cluster to which the medical test data belong is extracted from the medical test data.

In the operation performing process S130, machine learning or prediction using a prediction model is selectively performed according to the operation information that was received in the receiving process S100.

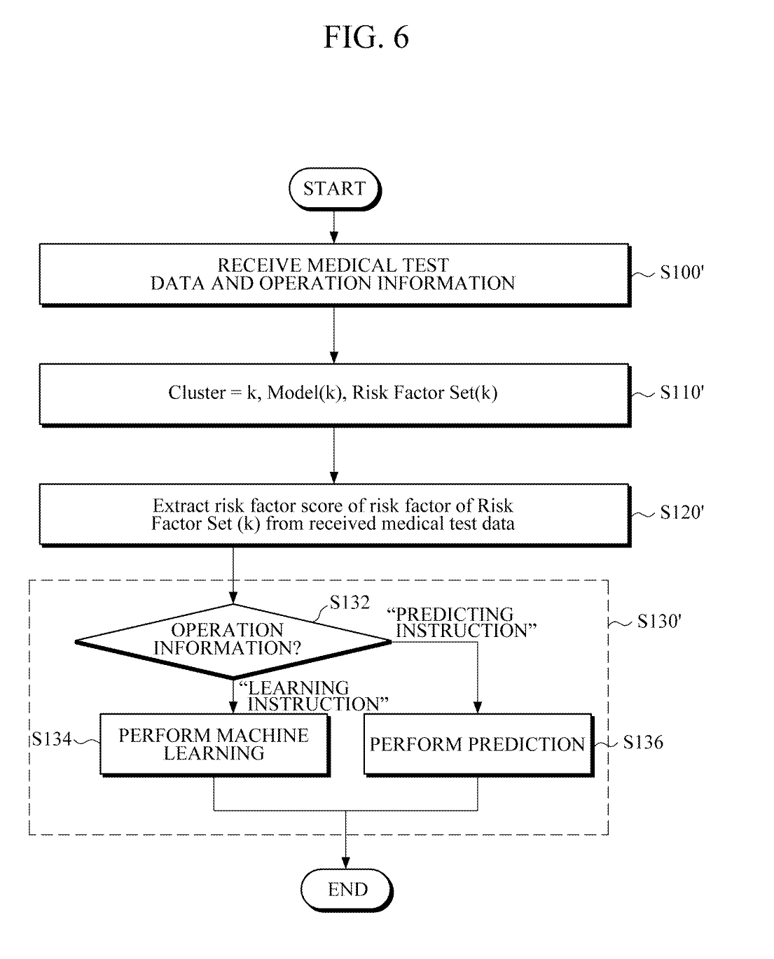

FIG. 6 is a flow chart illustrating a detailed example of the method of FIG. 5. Processes S100′, S110′, S120′, and S130′ of FIG. 6 respectively correspond to processes S100, S110, S120, and S130 of FIG. 5.

In a receiving process S100′, medical test data and corresponding operation information are received in a receiving unit of an apparatus for predicting a potential degree of CAC risk.

In a cluster determining process S110′, a cluster to which the received medical test data belong is determined based on a characteristic of the received medical test data, and a prediction model to be used with respect to the received medical test data is determined.

For example, in a case where a clustering technique requiring N clusters (1<k≦N) is used and the received medical test data belong to a k-th cluster, a prediction model Model (k) and a risk factor set Risk Factor Set (k) each corresponding to the k-th cluster are used. The Risk Factor Set (k) is a set of risk factors of the medical test data of the k-th cluster.

In a risk factor score extracting process S120′, a risk factor score of a risk factor of the Risk Factor Set (k) is extracted from the received medical test data. Different prediction models and different risk factor sets are used with respect to medical test data belonging to different clusters. Conversely, the same prediction model and the same risk factor set are used with respect to medical test data belonging to the same cluster.

An operation performing process S130′ includes an operation information determining process S132.

When the operation information is a “learning instruction”, the risk factor score extracted in the process S120′ for extracting a risk factor score is applied to the prediction model corresponding to a cluster to which the received medical test data belong to perform machine learning on the prediction model in a machine learning process S134.

When the operation information is a “predicting instruction”, the risk factor score extracted in the risk factor score extracting process S120′ is applied to a prediction model corresponding to a cluster to which the received medical test data belong to predict a patient's potential degree of CAC risk in a predicting process S136. The potential degree of CAC risk may be predicted at a specific point in time, for example, four years in the future. However, four years is merely one example, and other time periods may be used.

In the machine learning process S134, a reference CACS growth rate is calculated from the medical test data that have been used in performing machine learning. The reference CACS growth rate may be an average CACS growth rate of all of the medical test data belonging to the same cluster. A CACS growth rate calculated between the first measured CACS and the last measured CACS of each medical test data is compared with the reference CACS growth rate.

In the case where the CACS growth rate of the medical test data is greater than the reference CACS growth rate of the cluster to which the medical test data belong, an outcome (for example, “1”) indicating that a potential degree of CAC risk is predicted to increase is assigned. In other cases, an outcome (for example, “0”) indicating that a potential degree of CAC risk is predicted not to increase is assigned.

If machine learning is performed on a prediction model in the machine learning process S134 to present a potential degree of CAC risk in phases, the prediction model may be used to perform prediction with respect to different medical test data to thereby predict a potential degree of CAC risk according to an outcome.

For example, if an outcome of “1” is obtained with respect to the different medical test data in the predicting process S136, it may be predicted that a potential degree of CAC risk will increase. In contrast, if an outcome of “0” is obtained with respect to the different medical test data, it may be predicted that a potential degree of CAC risk will not increase.

As described above, if it is possible to predict whether a patient's potential degree of CAC risk will increase at a specific point in time (for example, four years in the future), high-risk patients may be appropriately treated with medication so that heart diseases, strokes, and other cardiovascular problems may be effectively prevented. In addition, the prediction may help low-risk patients avoid unnecessary medical tests and excessive preventive treatment.

The receiving unit 100, the cluster determining unit 110, the risk factor score extracting unit 120, the prediction model storage unit 130, the predicting unit 140, the receiving unit 200, the cluster determining unit 210, the risk factor score extracting unit 220, the prediction model storage unit 230, the prediction model learning unit 240, and the predicting unit 250 described above that perform the operations illustrated in FIGS. 6 and 7 may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of predicting a potential degree of Coronary Artery Calcification (CAC) risk, the method comprising:
receiving a patient's medical test data relating to CAC;
determining a cluster to which the patient's medical test data belong based on an age of the patient;
extracting a risk factor score comprising at least two Coronary Artery Calcification Scores (CACSs) from the patient's medical test data;
storing a plurality of prediction models used for predicting a potential degree of CAC risk; and
predicting a potential degree of CAC risk at a specific point in time by applying a CACS growth rate of the patient's medical test data calculated using the at least two CACSs of the patient's medical test data and the extracted risk factor score to a prediction model corresponding to the determined cluster to which the patient's medical test data belong among the plurality of prediction models.

2. The method of claim 1, wherein the predicting of the potential degree of CAC risk comprises comparing the CACS growth rate of the patient's medical test data with an average CACS growth rate of all medical test data of the determined cluster to which the patient's medical test data belong.

3. The method of claim 2, wherein the extracted risk factor score comprises any one or any combination of a body mass index (BMI) value, a high-density lipoprotein (HDL) cholesterol level, an age, a triglyceride level, and a value determined according to whether the patient is a smoker or a non-smoker.

4. An apparatus for predicting a potential degree of Coronary Artery Calcification (CAC) risk, the apparatus comprising:
a receiving unit configured to receive a patient's medical test data relating to CAC;
a cluster determining unit configured to determine a cluster to which the patient's medical test data belong based on an age of the patient;
a risk factor score extracting unit configured to extract a risk factor score comprising at least two Coronary Artery Calcification Scores (CACSs) from the patient's medical test data;
a prediction model storage unit configured to store a plurality of prediction models for predicting a potential degree of CAC risk; and
a predicting unit configured to predict a potential degree of CAC risk at a specific point in time by applying a CACS growth rate of the patient's medical test data calculated using the at least two CACSs of the patient's medical test data and the extracted risk factor score to a prediction model corresponding to the determined cluster to which the patient's medical test data belong among the plurality of prediction models.

5. The apparatus of claim 4, wherein the predicting unit is further configured to predict the potential degree of CAC risk by comparing the CACS growth rate of the patient's medical test data with an average CACS growth rate of all medical test data of the cluster to which the patient's medical test data belong.

6. The method of claim 5, wherein the extracted risk factor score comprises any one or any combination of a body mass index (BMI) value, a high-density lipoprotein (HDL) cholesterol level, an age, a triglyceride level, and a value determined according to whether the patient is a smoker or a non-smoker.

7. An apparatus for predicting a potential degree of Coronary Artery Calcification (CAC) risk, the apparatus comprising:
a receiving unit configured to receive a patient's medical test data relating to CAC and corresponding operation information;
a cluster determining unit configured to determine a cluster to which the patient's medical test data belong based on a characteristic of the patient;
a risk factor score extracting unit configured to extract from the patient's medical test data a risk factor score of a risk factor of a risk factor set of the determined cluster to which the patient's medical test data belong;
a prediction model storage unit configured to store a plurality of prediction models used for predicting a potential degree of CAC risk;
a prediction model learning unit configured to perform machine learning by applying the extracted risk factor score to a prediction model corresponding to the determined cluster among the plurality of prediction models; and
a predicting unit configured to obtain an outcome by applying the extracted risk factor score to the prediction model corresponding to the determined cluster.

8. The apparatus of claim 7, wherein the prediction model learning unit is further configured to perform the machine learning when the operation information is a learning instruction; and
the predicting unit is further configured to obtain the outcome when the operation information is the predicting instruction.

9. The apparatus of claim 8, wherein the extracted risk factor score comprises at least two Coronary Artery Calcification Scores (CACSs).

10. The apparatus of claim 9, wherein the characteristic of the patient is an age of the patient; and
the cluster determining unit is further configured to determine the cluster to which the patient's medical test data belong based on the age of the patient.

11. The apparatus of claim 10, wherein the prediction model learning unit is further configured to calculate a CACS growth rate of the patient's medical test data from the at least two CACSs.

12. The apparatus of claim 11, wherein the prediction model learning unit is further configured to perform the machine learning by:
comparing the CACS growth rate of the patient's medical test data with a reference CACS growth rate of all medical test data of the determined cluster to which the patient's medical test data belong;
assigning a first outcome to the patient's medical test data when the CACS growth rate of the patient's medical test data is greater than the reference CAC growth rate; and
assigning a second outcome to the patient's medical test data in other cases.

13. The apparatus of claim 12, wherein when the predicting unit obtains the first outcome when the patient's medical test data is received with the predicting instruction, a potential CAC risk of the patient is predicted to increase; and
when the predicting unit obtains the second outcome when the patient's medical test data is received with the predicting instruction, the potential CAC risk of the patient is predicted not to increase.

14. A method of predicting a potential degree of Coronary Artery Calcification (CAC) risk, the method comprising:
receiving a patient's medical test data relating to CAC and corresponding operation information;
determining a cluster to which the patient's medical test data belong based on a characteristic of the patient;
extracting from the patient's medical test data a risk factor score of a risk factor of a risk factor set of the determined cluster to which the patient's medical test data belong; and
selectively performing machine learning or prediction using a prediction model according to the operation information.

15. The method of claim 14, wherein the characteristic of the patient is an age of the patient; and
the determining of the cluster to which the patient's medical test data belong comprises determining the cluster to which the patient's medical test data belong based on the age of the patient.

16. The method of claim 15, wherein the selectively performing of the machine learning or the prediction using a prediction model comprises:
performing the machine learning by applying the extracted risk factor score to a prediction model corresponding to the determined cluster to which the patient's medical test data belong among a plurality of prediction models when the operation information is a learning instruction; and
performing the prediction by applying the extracted risk factor score to the prediction model corresponding to the determined cluster to which the patient's medical test data belong when the operation information is a predicting instruction.

17. The method of claim 16, wherein the extracted risk factor score comprises at least two Coronary Artery Calcification Scores (CACSs).

18. The method of claim 17, wherein the performing of the machine learning comprises calculating a CACS growth rate of the patient's medical test data using the at least two CACSs.

19. The method of claim 18, wherein the performing of the machine learning further comprises:
comparing the CACS growth rate of the patient's medical test data with a reference CACS growth rate of all medical test data of the determined cluster to which the patient's medical test data belong;
assigning a first outcome to the patient's medical test data when the CACS growth rate of the patient's medical test data is greater than the reference CACS growth rate; and
assigning a second outcome to the patient's medical test data in other cases.

20. The method of claim 19, wherein when the performing of the prediction using a prediction model obtains the first outcome when the patient's medical test data is received with the predicting instruction, a potential CAC risk of the patient is predicted to increase; and
when the performing of the prediction using a prediction model obtains the second outcome when the patient's medical test data is received with the predicting instruction, the potential CAC risk of the patient is predicted not to increase.
